(19) United States
(12) Patent Application Publication
(10) Pub. No.: US 2007/0204920 A1
(43) Pub. Date: Sep. 6, 2007

(54) FUEL TANK FOR A MOTOR VEHICLE

(76) Inventors: Paul Handy, D.N. Halutza (IL); Thorsten Kirchberger, Konigswinter (DE); Felix Muller-Ohl, Bonn (DE); Vladimir Olshanetsky, D.N. Halutza (IL); Theodor Ossege, Braunschweig (DE); Markus Schumacher, Beer Sheva (IL); Omer Vulkan, Sankt Augustin (DE); Hartmut Wolf, Konigswinter (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/669,562

(22) Filed: Jan. 31, 2007

Related U.S. Application Data
(60) Provisional application No. 60/776,698, filed on Feb. 27, 2006.
(60) Provisional application No. 60/806,485, filed on Jul. 3, 2006.

(30) Foreign Application Priority Data
Jan. 31, 2006 (DE) 10 2006 004630

(51) Int. Cl. B60K 15/035

(52) U.S. Cl. 137/588

(57) ABSTRACT

The invention concerns a fuel tank (1) for a motor vehicle comprising a filler connection (2) enclosing a tank refueling passage (11) and operational and tank refueling venting conduits (3, 4) which are connected to a filler head (6) of the filler connection (2), wherein the filler head (6) has at least one change-over switching valve (9) which in a first switching position (tank refueling position) opens a flow path from the tank refueling venting conduit (3) to a fuel vapor filter and closes a connection of the operational venting conduit (4) to the tank refueling passage (11), and which in a second switching position (operational position) opens the connection of the operational venting conduit (4) to the tank refueling passage (11) and closes the flow path from the tank refueling venting conduit (3) to the fuel vapor filter. The fuel tank according to the invention is distinguished in that the operational venting means is connected to the fuel vapor filter primarily by way of the change-over switching valve (9), wherein the change-over switching valve opens the flow path from the operational venting conduit (4) to the fuel vapor filter in the second switching position and closes same in the first switching position (FIG. 1).

The invention concerns a fuel tank for a motor vehicle comprising a filler connection enclosing a tank refueling passage and operational and tank refueling venting conduits which are connected to a filler head of the filler connection, wherein the filler head has at least one change-over switching valve which in a first switching position (tank refueling position) opens a flow path from the tank refueling venting conduit to a fuel vapor filter and closes a connection of the operational venting conduit to the tank refueling passage, and which in a second switching position (operational position) opens the connection of the operational venting conduit to the tank refueling passage and closes the flow path from the tank refueling venting conduit to the fuel vapor filter.

A fuel tank or a closure connection for a filler connection of a fuel tank of the above-indicated kind is known for example from DE 198 47 472 A1. DE 198 47 472 A1 describes a closure connection for a filler connection of a fuel tank of a motor vehicle comprising a flap which is arranged in a tank refueling passage and which is movable in the refueling operation, for switching a venting valve, comprising a first compensating chamber connected to the venting valve for tank refueling venting, and a second operational venting means connected to the venting valve, wherein the venting valve is adapted during operation to communicate the second compensating chamber with the tank refueling passage. That closure connection is distinguished in that there are provided interchange means for selectively connecting the first compensating chamber by way of a change-over switching valve to a filter or the tank refueling passage so that the closure connection can be adapted to different tank refueling systems.

In a variant of the tank refueling venting means, which is described in DE 198 47 472 A1, the gas volume flow which occurs upon refueling of the motor vehicle is discharged into the atmosphere by way of a compensating chamber and by way of a fuel vapor filter. Provided in the flow path between the compensating chamber in question and the fuel vapor filter is a valve member which closes the flow path in operation of the vehicle and opens it in a tank refueling situation. Operational venting for the motor vehicle is evidently effected in conventional manner in the venting system described in DE 198 47 472 A1.

In the operational venting situation, a plurality of venting points on the fuel tank are usually connected together by way of one or more operational venting conduits which are also connected to the fuel vapor filter. The venting points are normally disposed above the maximum permissible level of liquid in the fuel tank and are usually closed by float valves. Those valves also have a pressure-holding function or separate pressure-holding valves are provided in order to prevent overfilling of the fuel tank, in order to cause the refueling gun valve to shut off in good time during refueling.

A comparatively large number of valves have to be provided, depending on the respective number of venting locations to be provided in the fuel tank. If the valves are in the form of float valves, spillage of fuel over into one vent conduit or the other is inevitable, because of valve inertia. The pressure-holding valves also have a certain amount of leakage so that the risk of overfilling the tank rises with an increase in the number of the venting locations.

In addition it is desirable for the fuel tank to be kept substantially pressure-less during operation of the motor vehicle.

DE 195 40 267 B4 discloses a tank venting system for a fuel tank with an expansion region, a filler connection which is closable by a tank closure, a venting conduit connected to the expansion region and a venting valve, wherein the venting valve is adapted to close the venting conduit when the filler connection is open and to open the venting conduit when the filler connection is closed. The shut-off valve provided for that purpose between the fuel vapor filter and the venting conduits of the fuel tank is arranged at the filler head of the filler connection, wherein the closure cap which is screwed into the filler connection causes actuation of the shut-off valve in such a way that the flow path from the operational venting conduits to the fuel vapor filter is opened.

The tank venting system proposed in DE 195 40 267 B4 is suitable exclusively for tank refueling venting in accordance with the European system in which the fuel vapors produced are sucked away by means of a suitable device at the refueling gun. Integration of tank refueling venting as is provided in the closure connections in accordance with DE 198 47 472 A1 is not embodied in the tank venting system disclosed in DE 195 40 267 B4.

The invention is therefore based on the object of improving a fuel tank of the kind set forth in the opening part of this specification, in terms of operational and tank refueling venting. In particular the invention aims to provide that the fuel tank permits substantially pressure-less venting during operation of the motor vehicle and is also to be as simple and inexpensive as possible to produce having regard to the bead removal, catch and compensating volumes which are otherwise required.

The object is attained by a fuel tank for a motor vehicle comprising a filler connection enclosing a tank refueling passage and operational and tank refueling venting conduits which are connected to a filler head of the filler connection, wherein the filler head has at least one change-over switching valve which in a first switching position (tank refueling position) opens a flow path from the tank refueling venting conduit to a venting passage, upstream of which a fuel vapor filter is preferably connected, and closes a connection of the operational venting conduit to the tank refueling passage, and which in a second switching position (operational position) opens the connection of the operational venting conduit to the tank refueling passage and closes the flow path from the tank refueling venting conduit to the venting passage, wherein the fuel tank is distinguished in that the operational venting means is connected to the fuel vapor filter exclusively by way of the change-over switching valve, and wherein the change-over switching valve opens the flow path from the operational venting conduit to the fuel vapor filter in the second switching position and closes same in the first switching position.

The fuel tank according to the invention has the advantage over the state of the art that the various venting points of the fuel tank do not require any pressure-holding valves, and the air intake conduit can be connected directly to the fuel vapor filter, wherein selectively tank refueling venting or operational venting can be effected by way of the fuel vapor filter to the atmosphere.

It is particularly advantageous if the connection of the operational venting conduit to the fuel vapor filter has a fuel drainage into the tank refueling passage. The fuel drainage is preferably of such a configuration that the condensed or entrained fuel runs off into the tank refueling passage only under the effect of the force of gravity.

That affords the advantage that, in the fuel tank according to the invention, the tank refueling venting conduit can be connected to the filler head without the interposition of a bead removal container or a compensating chamber. Additional bead removal, catch or compensating volumes are therefore not required.

Desirably, in the second switching position of the change-over switching valve the operation venting conduit is connected pressure-lessly open to the fuel vapor filter. Pressure-less in the sense of the invention means that pressure losses occur only by virtue of the conduit cross-section itself and the resistance of the fuel vapor filter.

It is particularly advantageous if there is provided in the flow path between the tank refueling venting conduit and the fuel vapor filter a connection to the tank refueling passage, which is in the form of a recirculation opening or recirculation passage.

In that way a part of the gases which are displaced out of the tank volume in the tank refueling operation is recirculated through the tank refueling passage so as to avoid excessive loading of the fuel vapor filter with liquid hydrocarbons.

In a variant of the fuel tank according to the invention between the tank refueling passage and the venting passage there is provided a roll-over valve which upon fuel blowback in the filler pipe closes at least the way to the fuel vapor filter, so that when the vehicle rolls over fuel is reliably prevented from overflowing out of the filler pipe into the fuel vapor filter and into the surroundings.

The invention is described hereinafter by means of an embodiment by way of example illustrated in the drawings in which:

FIG. 1 is a diagrammatic plan view of a fuel tank according to the invention,

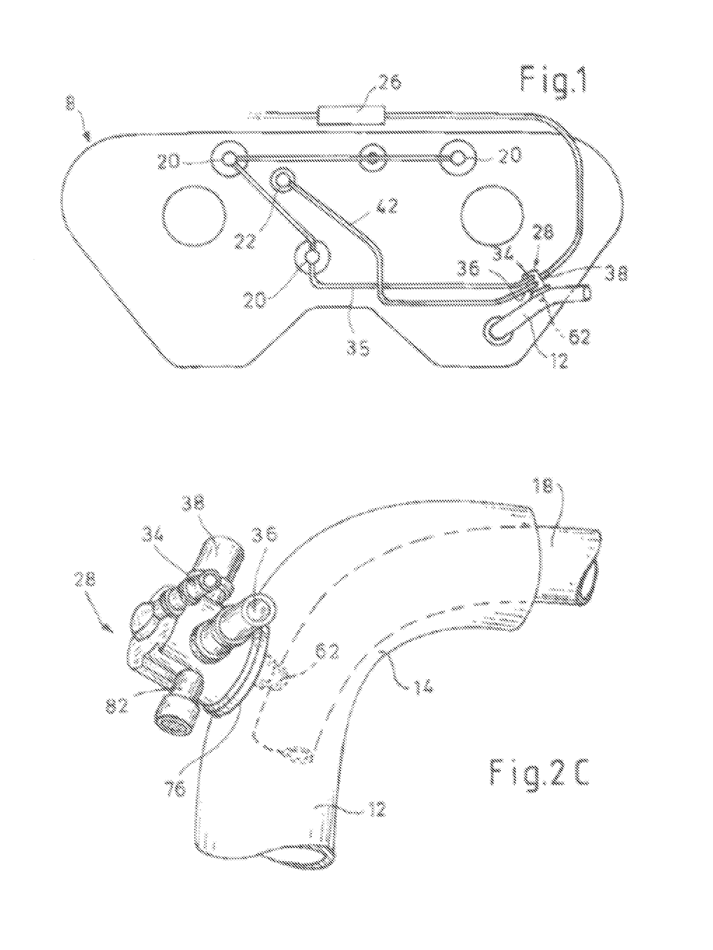

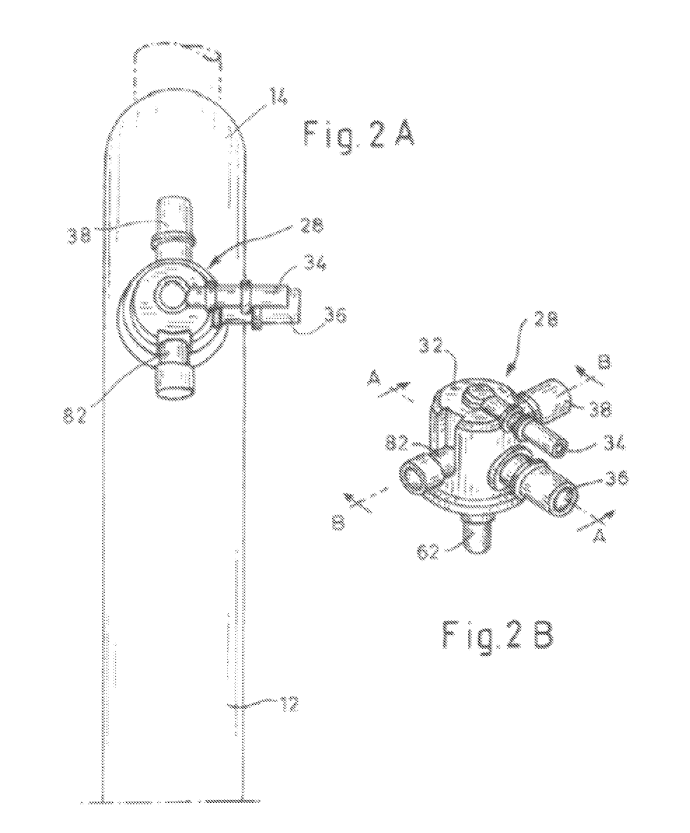

FIG. 2 is a greatly simplified view in section through the filler head of the filler pipe on the fuel tank shown in FIG. 1, operational venting being shown in FIG. 2, and

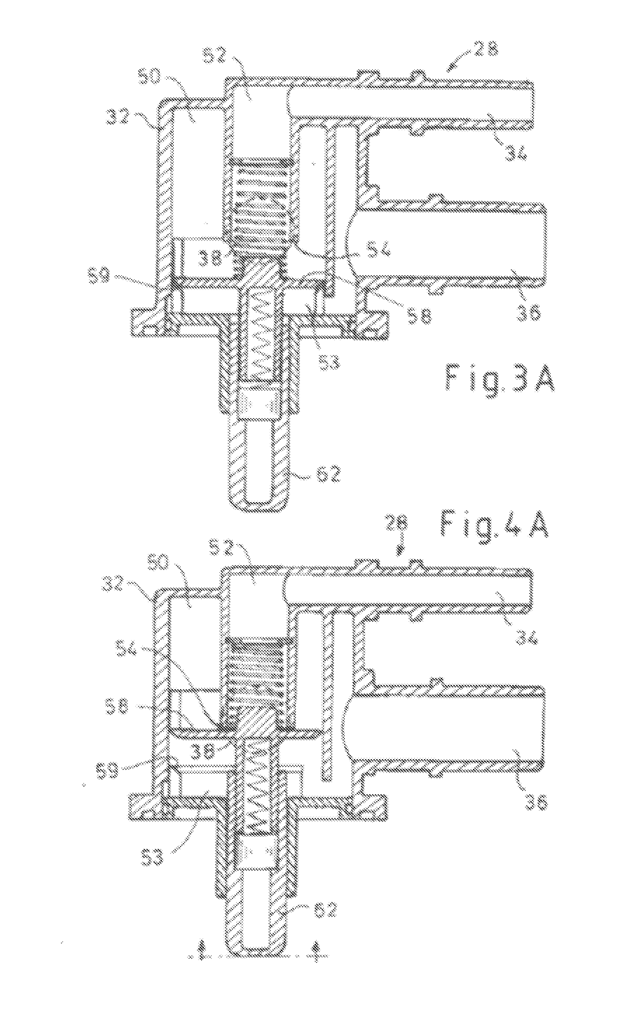

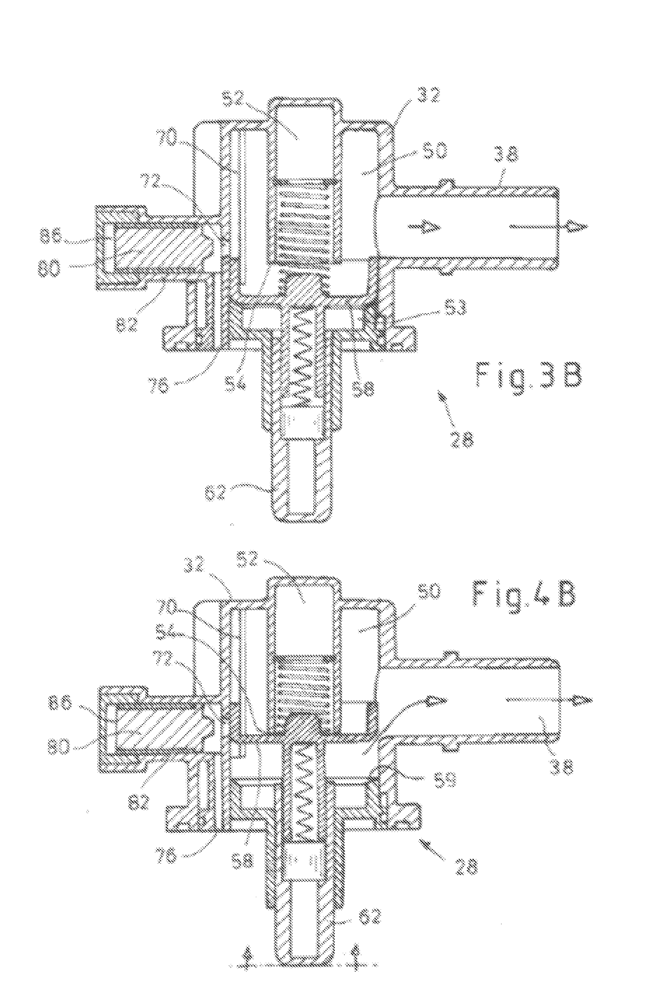

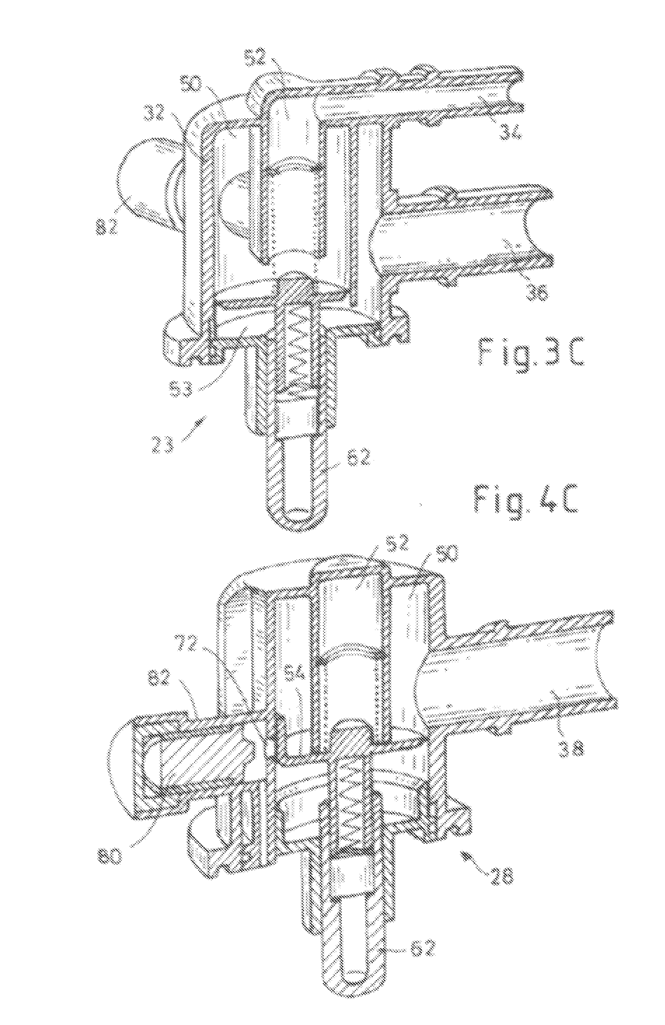

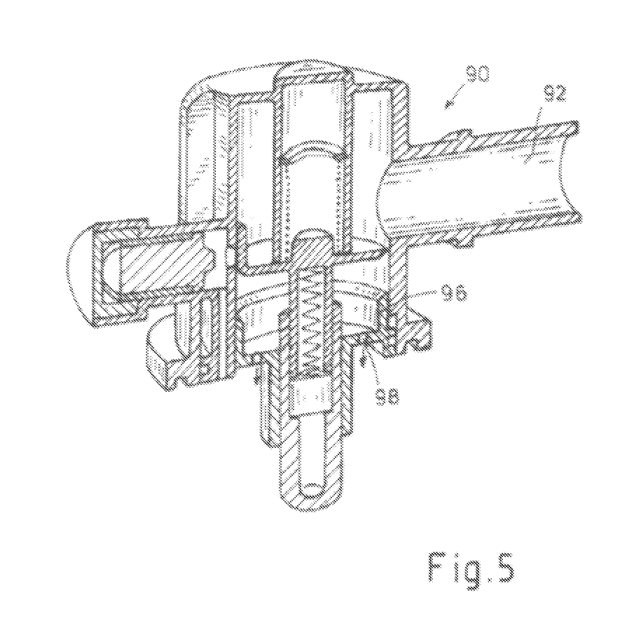

FIG. 3 is a view corresponding to FIG. 2 showing tank refueling venting.

The fuel tank 1 shown in FIG. 1 is provided in known manner with a filler connection 2, a tank refueling venting conduit 3 and operational venting conduits 4. When filling the fuel tank 1 the gas volume which is displaced by the inflowing fuel and which is produced above the surface of the fuel in the tank escapes by way of the tank refueling venting conduit 3 in known manner. The gas volume flow which occurs in operation of the vehicle due to the effect of temperature or due to a surge movement of the vehicle escapes from the fuel tank 1 by way of the operational venting conduits 4 which are connected to the fuel tank at what are referred to as venting points 5.

The venting points 5 are disposed at locations on the fuel tank 1, of which at least one is always arranged above the level of liquid.

As already mentioned in the opening part of this specification, the level of fuel in the fuel tank 1 may not exceed a certain height in the refueling operation so that sufficient expansion volume remains in the fuel tank 1.

In the illustrated embodiment, both the tank refueling venting conduits 3 and also the operational venting conduits 4 are connected to the filler head 6 of the filler connection 2. Also connected thereto is a venting passage 7 to a fuel vapor filter (not shown).

The filler head 6 is diagrammatically shown in FIGS. 2 and 3. It includes a change-over switching valve 9 with which, depending on the respective operating state of the vehicle, the operational venting conduit 4 or the tank refueling venting conduit 3 can be selectively communicated with the fuel vapor filter. The change-over switching valve 9 is actuated by way of a control member 10 which is only diagrammatically illustrated here. In the refueling operation the control member 10 is in turn actuated either indirectly or directly by the refueling gun which is inserted into the refueling head 6. It is however basically also conceivable to provide for actuation of the change-over switching valve 9 by way of a closure cap which is to be fitted onto the filler connection 2.

The illustrated embodiment provides that the refueling gun which is inserted into the tank refueling passage 11 acts directly or by way of a closure cap on the control member 10 which is provided with a first and a second closure element 12a and 12b. Provided in known manner at the end of the filler connection 2, which opens into the tank volume, is a check valve or a check flap which in a roll-over situation prevents fuel from the tank from passing into the filler pipe 2.

FIG. 2 shows what is referred to as the operational position of the change-over switching valve 9 in which the flow path 4/7 from the operational venting conduit 4 into the venting passage 7 to the fuel vapor filter (not shown) is opened. At the same time the flow path 3/7 from the tank refueling venting conduit 3 into the venting conduit 7 to the fuel vapor filter is closed. The hydrocarbon-charged gases which occur in operation of the motor vehicle pass out of the tank volume into the fuel vapor filter, more specifically without the interposition of further valves. By virtue of the comparatively great conduit length, a part of the fuel already condenses upstream of the change-over switching valve 9 in the flow direction. Provided in the change-over switching valve 9 is a drainage path 13 for fuel, which communicates the flow path 4/7 with the tank refueling passage 11, so that liquid fuel entrained in the operational venting conduit 4 flows back into the tank refueling passage 11. In that respect the conduit configuration is so selected that this takes place as far as possible using the force of gravity. The drainage path 13 makes it possible to incorporate the filler connection 2 into what is referred to as OBD checking (on board diagnostics).

In the switching condition shown in FIG. 2 (operational position) the first closure element 12a is lifted off its seat or is in the opened condition, and the second closure element 12b closes the tank refueling venting conduit 3. In order to protect the fuel vapor filter from ingress of liquid fuel in extreme operational states of the motor vehicle, the flow path from the tank refueling passage 11 into the venting passage 7 is additionally safeguarded by way of a roll-over valve (not shown).

FIG. 3 shows the tank refueling position of the change-over switching valve 9. In that position the refueling gun has lifted the control member 10 upon being introduced into the tank refueling passage 11 so that the first closure element 12a is pressed into its seat and closes the path between the venting conduits 3, 4 and 7 to the tank refueling passage 11. The second closure element 12b in contrast has opened the flow path 3/7 from the tank refueling venting conduit 3 into the venting passage 7 and closed the flow path 4/7 from the operational venting conduit 4 into the venting passage 7. In that tank refueling position of the change-over switching valve 9 the gas volume flow which is displaced by the inflowing fuel is passed by way of the tank refueling venting conduit 3 and the venting passage 7 to the fuel vapor filter which is preferably in the form of an activated carbon filter.

Provided in the first closure element 12a is a recirculation opening 14, the width of which is comparatively small in relation to the flow path covered over by the first closure element 12a. As a result of the different flow resistances which occur through the fuel vapor filter and through the recirculation opening 14, a part of the gas displaced by the liquid is fed back into the fuel tank by way of the recirculation opening 14.

### LIST OF REFERENCES

1 fuel tank
2 filler connection
3 tank refueling venting conduit
4 operational venting conduits
5 venting points
6 filler head
7 venting passage
9 change-over switching valve
10 control member
11 tank refueling passage
12a first closure element
12b second closure element
4/7 flow path in operation of the vehicle
3/7 flow path in refueling of the vehicle
13 drainage path
14 recirculation opening

1. A fuel tank (1) for a motor vehicle comprising a filler connection (2) enclosing a tank refueling passage (11) and operational and tank refueling venting conduits (3, 4) which are connected to a filler head (6) of the filler connection (2), wherein the filler head (6) has at least one change-over switching valve (9) which in a first switching position (tank refueling position) opens a flow path from the tank refueling venting conduit (3) to a venting passage (7), upstream of which a fuel vapor filter is preferably connected, and closes a connection of the operational venting conduit (4) to the tank refueling passage (11), and which in a second switching position (operational position) opens the connection of the operational venting conduit (4) to the tank refueling passage (11) and closes the flow path from the tank refueling venting conduit (3) to the venting passage (7) characterized in that the operational venting means is connected to the venting passage (7) exclusively by way of the change-over switching valve (9), wherein the change-over switching valve opens the flow path from the operational venting conduit (4) to the venting passage (7) in the second switching position and closes same in the first switching position.

2. A fuel tank as set forth in claim 1 characterized in that the connection of the operational venting conduit (4) to the fuel vapor filter has a fuel drainage into the tank refueling passage (11).

3. A fuel tank as set forth in one of claims 1 and 2 characterized in that the tank refueling venting conduit (3) is connected to the filler head (6) without the interposition of a bead removal container or a compensating chamber.

4. A fuel tank as set forth in one of claims 1 through 3 characterized in that in the second switching position of the change-over switching valve (9) the operation venting conduit (4) is connected pressure-lessly to the fuel vapor filter.

5. A fuel tank as set forth in one of claims 1 through 4 characterized in that there is provided in the flow path between the tank refueling venting conduit (3) and the fuel vapor filter at least one connection to the tank refueling passage (11), which is in the form of a recirculation opening or recirculation passage.

6. A fuel tank as set forth in one of claims 1 through 5 characterized in that between the tank refueling passage (11) and the venting passage (7) there is provided a rollover valve which upon fuel blowback in the filler pipe closes at least the way to the fuel vapor filter.
